(19) United States
(12) Patent Application Publication
(10) Pub. No.: US 2008/0030067 A1
(43) Pub. Date: Feb. 7, 2008

(54) Wheel device for a frame

(75) Inventors: Jui-Tien Chen, Kaohsiung City (TW); Chun-Ching Chen, Kaohsiung Hsien (TW)

Correspondence Address: DLA PIPER US LLP, 2000 UNIVERSITY AVENUE, E. PALO ALTO, CA, 94303-2248, US

(73) Assignee: Kwang Yang Motor Co., Ltd.

(21) Appl. No.: 11/810,423

(22) Filed: Jun. 4, 2007

(30) Foreign Application Priority Data
Jun. 16, 2006 (TW) 095121633

(51) Int. Cl. B60B 37/00

(52) U.S. Cl. 301/1

(57) ABSTRACT

A wheel device for a frame includes a wheel unit and a coupling unit for coupling the wheel unit to the frame. The coupling unit includes an upright tubular sleeve mounted fixedly on the frame, a support axle extending movably through the tubular sleeve and having a bottom end connected to the wheel unit, and a fastening member extending radially through the tubular sleeve and abutting releasably against the support axle for positioning the support axle in the tubular sleeve.

### CROSS-REFERENCE TO RELATED APPLICATION

This application claims priority of Taiwanese application no. 095121633, filed on Jun. 16, 2006.

### BACKGROUND OF THE INVENTION

1. Field of the Invention

The invention relates to a wheel device, more particularly to a wheel device for a frame.

2. Description of the Related Art

It is known in the art to provide a power generator with four wheels at a bottom part thereof to facilitate moving the power generator from one location to another. However, since the wheels in the prior art are unable to prevent rolling when the power generator is placed on uneven ground, the power generator can hardly be disposed stably on the ground. Moreover, since the wheels are designed primarily to facilitate moving of the power generator between locations, the power generator can easily move on the ground when bumped. Undesired movement of the power generator can result in sparks due to sudden disconnection from electrical appliances, which arises in safety concerns. Furthermore, the wheels are disposed outside the outer periphery of the bottom part of the power generator such that the are a occupied by the power generator with the wheels is undesirably increased.

### SUMMARY OF THE INVENTION

Therefore, the object of the present invention is to provide a wheel device that can overcome at least one of the aforesaid drawbacks associated with the prior art.

According to the present invention, there is provided a wheel device for a frame. The wheel device includes a wheel unit and a coupling unit for coupling the wheel unit to the frame. The coupling unit includes an upright tubular sleeve adapted to be mounted fixedly on the frame, a support axle that extends movably through the tubular sleeve and that has a bottom end connected to the wheel unit, and a fastening member extending radially through the tubular sleeve and abutting releasably against the support axle for positioning the support axle in the tubular sleeve.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a wheel device according to the present invention;

FIG. 2 is a schematic partly sectional view to illustrate a fastened state of a support axle of the preferred embodiment;

FIG. 3 is an assembled perspective view of the preferred embodiment;

FIG. 4 is a view similar to FIG. 2, but illustrating an unfastened state of the support axle; and

FIG. 5 is a view similar to FIG. 3, but illustrating the support axle when displaced upwardly compared to FIG. 3.

### DETAILED DESCRIPTION OF THE PREFERRED EMBODIMENT

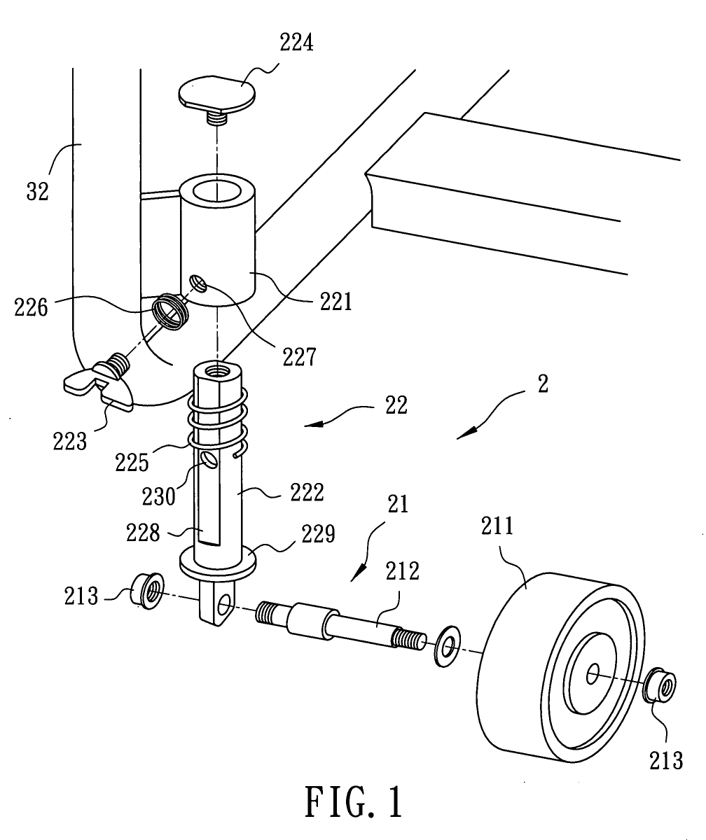

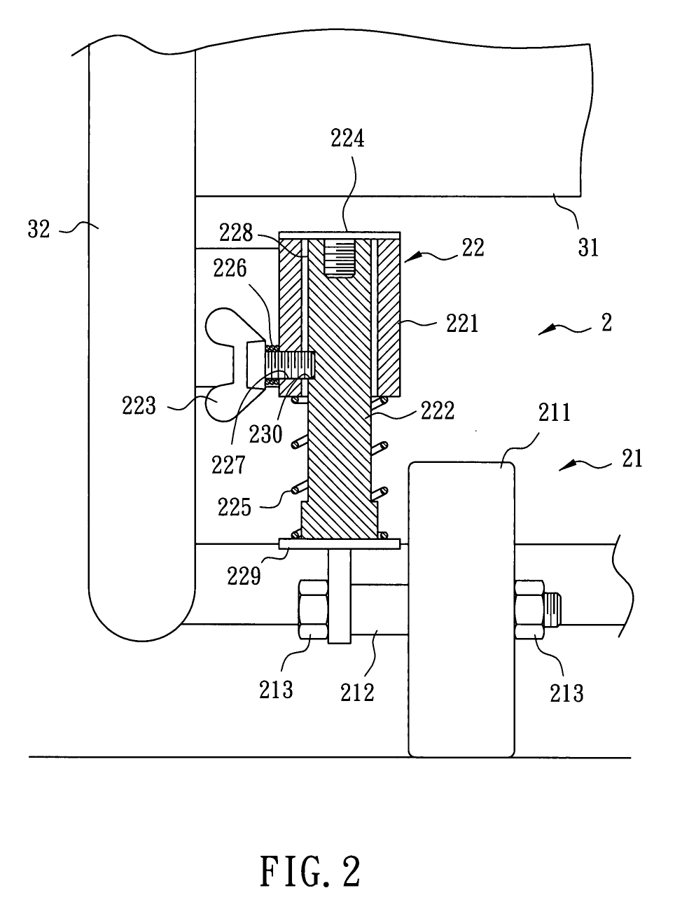

Referring to FIGS. 1 and 2, the preferred embodiment of a wheel device 2 according to the present invention is applied to a frame 32 that carries a power generator 31. The wheel device 2 is mounted on a bottom part of the frame 32, and includes four wheel units 21 and four coupling units 22 for coupling the wheel units 21 to the frame 32, respectively. In the Figures, only a corner of the power generator 31 and the frame 32, and one of the wheel units 21 and a corresponding one of the coupling units 22 are shown for convenience of illustration. In practice, each of the four corners of the frame 32 is associated with a respective set of the wheel unit 21 and the coupling unit 22.

Each of the coupling units 22 includes an upright tubular sleeve 221 adapted to be mounted fixedly on the frame 32, a support axle 222 that extends movably through the tubular sleeve 221 and that has a bottom end connected to the respective wheel unit 21, and a fastening member 223 that extends radially through the tubular sleeve 221 and that abuts releasably against the support axle 222 for positioning the support axle 222 in the tubular sleeve 221. The support axle 222 is formed with a radial flange 229 proximate to the bottom end and disposed below the tubular sleeve 221. The coupling unit 22 further includes a cap 224 connected to a top end of the support axle 222 and disposed above the tubular sleeve 221. The cap 224 and the radial flange 229 cooperate to limit range of movement of the support axle 222 relative to the tubular sleeve 221. The coupling unit 22 further includes a first biasing member 225 that is sleeved on the support axle 222 and that has opposite ends abutting against the radial flange 229 and a bottom end face of the tubular sleeve 221, respectively. The first biasing member 225 is in the form of a spring in this embodiment. Moreover, in this embodiment, the tubular sleeve 221 is formed with a radial screw hole 227, and the fastening member 223 is in the form of a threaded fastener that extends through and that engages threadedly the radial screw hole 227. The coupling unit 22 further includes a second biasing member 226 that is sleeved on the fastening member 223 and that has opposite ends abutting against a head part of the fastening member 223 and an outer side of the tubular sleeve 221, respectively. In this embodiment, the second biasing member 226 is in the form of a spring.

Preferably, the support axle 222 has a flat side 228 registered with the radial screw hole 227 and formed with a positioning groove 230. The fastening member 223 is extendible removably into the positioning groove 230.

Each of the wheel units 21 includes a wheel axle 212 connected to the bottom end of the support axle 222, and a wheel body 211 mounted rotatably on the wheel axle 212. The wheel axle 212 has opposite threaded ends that extend through the support axle 222 and the wheel body 211, respectively. The wheel unit 21 further includes a pair of nuts 213 on the opposite threaded ends of the wheel axle 212. The nuts 213 serve to secure the wheel axle 212 to the bottom end of the support axle 222, and to secure rotatably the wheel body 211 on the wheel axle 212.

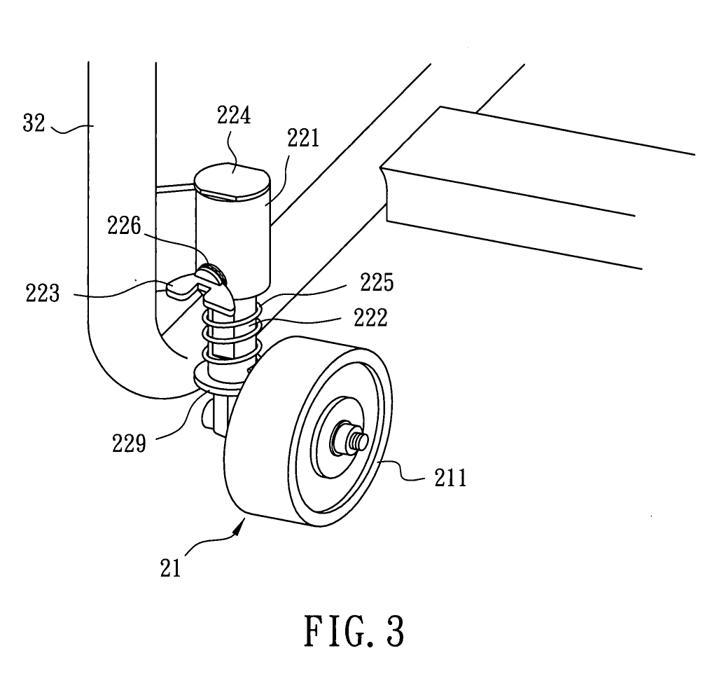

Referring to FIGS. 2 and 3, when moving the power generator 31 on the frame 32 to a desired location, for each coupling unit 22, the fastening member 223 is loosened so that the support axle 222 is able to move upward and downward in the tubular sleeve 221. Thus, when the associated corner of the frame 32 is lifted from the ground, the support axle 222 moves downwardly in the tubular sleeve 221 by virtue of gravity and the biasing force of the first biasing member 225 until the cap 224 abuts against a top end face of the tubular sleeve 221. The fastening member 223 is then tightened to extend into the positioning groove 230 and abut against the support axle 222 so as to position the support axle 222 in the tubular sleeve 221. At this time, the wheel body 221 of the respective wheel unit 21 protrudes from the bottom side of the frame 32 and can roll on the ground. Since the frame 32 is spaced apart from the ground, the power generator 31 on the frame 32 can be easily moved to a desired location.

Moreover, for each coupling unit 22, wear between the fastening member 223 and the tubular sleeve 221, as well as undesired loosening of the fastening member 223, can be avoided due to the presence of the second biasing member 226.

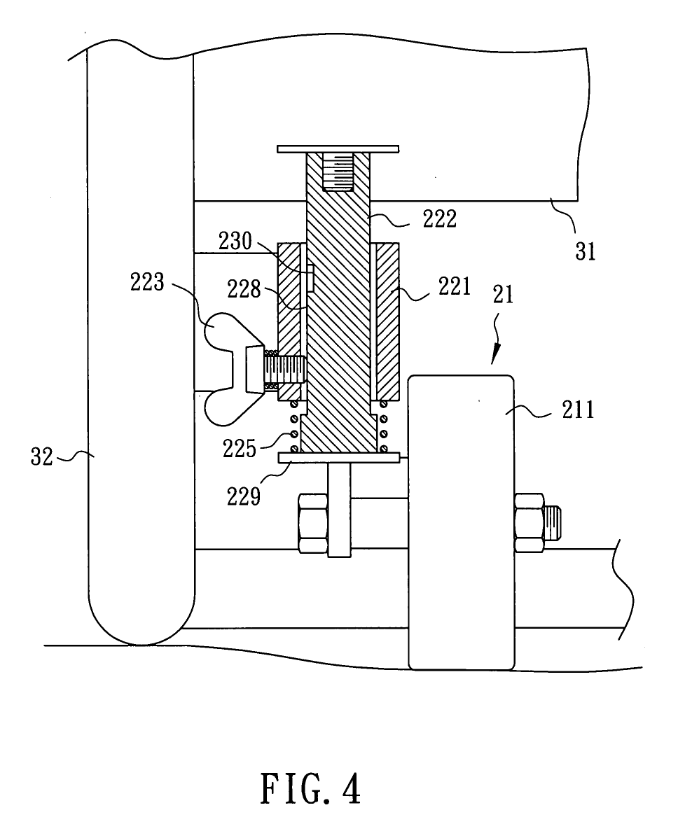

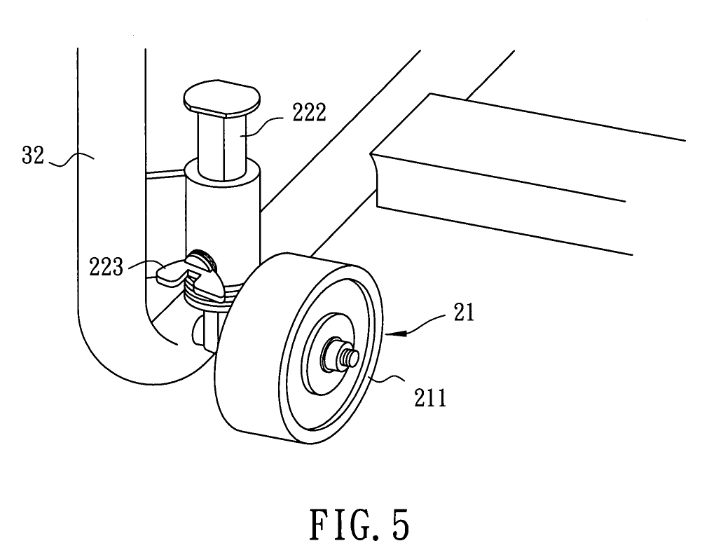

Referring to FIGS. 4 and 5, when parking the power generator 31 on the frame 32 at a desired location, for each coupling unit 22, the fastening member 223 is loosened so as to be disengaged from the positioning groove 230 in the support axle 222 such that the tubular sleeve 221 is able to move downward with the frame 32 until the frame 32 contacts the ground. At this time, the first biasing member 225 is compressed between the tubular sleeve 221 and the radial flange 229, and accumulates a restoring force. Even if the power generator 31 is parked on uneven ground as shown in FIG. 4, the first biasing member 225 biases the support axle 222 such that appropriate contact between the wheel body 211 of the corresponding wheel unit 21 and the ground can be ensured. The fastening member 223 is then tightened to abut tightly against the flat side 228 of the support axle 222.

Therefore, when the power generator 31 is parked, the coupling units 22 are independently adjusted so that the wheel bodies 211 of the wheel units 21 can retract into the frame 32 and enable the frame 32 to contact the ground directly, thereby ensuring stability. Due to the first biasing members 225, the wheel bodies 211 can still contact the ground to provide additional support points for the power generator 31 and avoid unintentional movement of the power generator 31.

In addition, since the wheel device 2 is mounted on and can be received in the frame 32, the are a occupied by the frame 32 is not increased when the wheel device 2 of this invention is in use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wheel device for a frame, said wheel device comprising a wheel unit and a coupling unit adapted for coupling said wheel unit to the frame, said coupling unit including
an upright tubular sleeve adapted to be mounted fixedly on the frame,
a support axle extending movably through said tubular sleeve, and having a bottom end connected to said wheel unit, and
a fastening member extending radially through said tubular sleeve, and abutting releasably against said support axle for positioning said support axle in said tubular sleeve.

2. The wheel device as claimed in claim 1, wherein said support axle further has a top end, said coupling unit further including a cap connected to said top end of said support axle and disposed above said tubular sleeve, said support axle being formed with a radial flange proximate to said bottom end and disposed below said tubular sleeve, said cap and said radial flange cooperating to limit range of movement of said support axle relative to said tubular sleeve.

3. The wheel device as claimed in claim 2, wherein said coupling unit further includes a biasing member that is sleeved on said support axle and that has opposite ends abutting against said radial flange and said tubular sleeve.

4. The wheel device as claimed in claim 1, wherein said support axle has a flat side formed with a positioning groove, said fastening member being extendible removably into said positioning groove.

5. The wheel device as claimed in claim 1, wherein said tubular sleeve is formed with a radial screw hole to engage threadedly said fastening member.

6. The wheel device as claimed in claim 5, wherein said coupling unit further includes a biasing member that is sleeved on said fastening member and that has opposite ends abutting against said fastening member and said tubular sleeve.

7. The wheel device as claimed in claim 1, wherein said wheel unit includes a wheel axle connected to said bottom end of said support axle, and a wheel body mounted rotatably on said wheel axle.
